(19) United States
(12) Patent Application Publication
(10) Pub. No.: US 2025/0216584 A1
(43) Pub. Date: Jul. 3, 2025

(54) OPTICAL LAMINATE AND IMAGE DISPLAY DEVICE INCLUDING SAME

(71) Applicant: DONGWOO FINE-CHEM CO., LTD., Iksan-si (KR)

(72) Inventors: Hyeong-Joo PARK, Iksan-si (KR); Ji-Hun JEONG, Iksan-si (KR); Young-Min CHO, Iksan-si (KR); Geo-San LIM, Iksan-si (KR)

(73) Assignee: DONGWOO FINE-CHEM CO., LTD., Iksan-si (KR)

(21) Appl. No.: 19/000,203

(22) Filed: Dec. 23, 2024

(30) Foreign Application Priority Data
Dec. 27, 2023 (KR) 10-2023-0192596

(51) Int. Cl. G02B 1/14; C03C 17/34

(52) U.S. Cl. CPC G02B 1/14; C03C 17/3405; C03C 2217/29; C03C 2217/78

(57) ABSTRACT

The present disclosure relates to an optical laminate including: glass; a first hard coating layer formed on the glass; and a second hard coating layer formed on the first hard coating layer, wherein the first hard coating layer is formed of a first hard coating composition comprising an epoxy acrylic resin and an epoxy silane coupling agent, and the second hard coating layer is formed of a second hard coating composition comprising a light-transmitting resin, and an image display device including the same.

### CROSS-REFERENCE TO RELATED APPLICATION(S)

This application claims the benefit under 35 USC 119 (a) of Korean Patent Application No. KR 10-2023-0192596, filed on Dec. 27, 2023, with the Korean Intellectual Property Office, the disclosure of which is incorporated herein by reference in its entirety.

### TECHNICAL FIELD

The present disclosure relates to an optical laminate and an image display device including the same.

### BACKGROUND ART

Recently, image display devices such as liquid crystal display (LCD) devices or organic light emitting display (OLED) devices have continuously been subjected to thinning and becoming flexible. The image display devices are widely applied to various smart devices characterized by portability, such as smart phones, tablet PCs, and various wearable devices. Such flexible displays require a glass substrate layer having properties such as high transparency, hardness, bending characteristics, etc.

Meanwhile, in the case of cover windows for flexible displays, the cover glass may frequently break when folded frequently or when an impact of the limit or beyond the limit is applied. In addition, a method of forming a thick protective coating to prevent the cover glass from being destroyed has been presented, but there is a disadvantage in that curling occurs severely due to curing shrinkage when a high-hardness acrylic oligomer is thickly coated.

Korean Patent No. 10-2336592 provides a resin composition for coating a flexible cover window and a flexible cover window characterized in that a resin layer made of the resin composition for coating a flexible cover window is formed on one surface or both surfaces of the flexible cover window.

However, the flexible cover window has a disadvantage in that curls or cracks occur when forming a thick film with an acrylic oligomer.

Therefore, there is a need to develop an optical laminate that causes less curls or cracks due to curing shrinkage even when thickly coated using an acrylic oligomer.

### RELATED ART DOCUMENT

### Patent Document

(Patent Document 1) Korean Patent No. 10-2336592

### DISCLOSURE

### Technical Problem

In order to solve the above-described problems, one object of the present disclosure is to provide an optical laminate that causes less curls or cracks due to curing shrinkage even at a thickness of a certain level or more.

Specifically, another object of the present disclosure is to provide an optical laminate that has high hardness and excellent adhesion, pen usability, curl characteristics, water contact angle, and scratch resistance, and an image display device including the same.

However, the problems to be solved by the present disclosure are not limited to the problems mentioned above, and other problems not mentioned will be clearly understood by those skilled in the art from the description below.

### Technical Solution

In order to achieve the above technical objects, the present disclosure provides an optical laminate including: glass; a first hard coating layer formed on the glass; and a second hard coating layer formed on the first hard coating layer, wherein the first hard coating layer is formed of a first hard coating composition comprising an epoxy acrylic resin and an epoxy silane coupling agent, and the second hard coating layer is formed of a second hard coating composition comprising a light-transmitting resin.

In the present disclosure, glass may have a thickness of 10 to 100 μm.

In the present disclosure, the first hard coating layer may have a thickness of 10 to 30 μm.

In the present disclosure, the second hard coating layer may have a thickness of 3 to 20 μm.

In the present disclosure, one or more of the first hard coating composition and the second hard coating composition may further include an additive.

In the present disclosure, the additive may include one or more selected from the group consisting of a silicone-based leveling agent, an ultraviolet stabilizer, and a heat stabilizer.

In the present disclosure, one or more hard coating compositions of the first hard coating composition and the second hard coating composition may further include an initiator and a solvent.

In the present disclosure, the first hard coating composition may include, based on the total weight of the composition, 20 to 80 parts by weight of an epoxy acrylic resin; 1 to 30 parts by weight of an epoxy silane coupling agent; 0.1 to 10 parts by weight of an initiator; and 50 to 98 parts by weight of a solvent.

In the present disclosure, the second hard coating composition may include, based on the total weight of the composition, 1 to 80 parts by weight of a light-transmitting resin; 0.1 to 10 parts by weight of an initiator; and 50 to 98 parts by weight of a solvent.

In the present disclosure, the epoxy silane coupling agent may include one or more selected from 3-glycidoxypropyldimethoxysilane, 3-glycidoxypropyltrimethoxysilane, 8-glycidoxyoctyltrimethoxysilane, and 2-(3,4-epoxycyclohexyl)ethyltrimethoxysilane.

In the present disclosure, the light-transmitting resin may include one or more selected from 2-hydroxyethyl (meth)acrylate, 2-hydroxyisopropyl (meth)acrylate, 4-hydroxybutyl (meth)acrylate, caprolactone ring-opening hydroxyacrylate, pentaerythritol tri/tetra (meth)acrylate, and dipentaerythritol penta/hexa (meth)acrylate.

In the present disclosure, glass, the first hard coating layer, and the second hard coating layer may be characterized in that they are formed by directly contacting each other without including a separate layer.

In the present disclosure, the optical laminate may be for being applied to a flexible display.

Furthermore, the present disclosure provides an image display device including the optical laminate.

### Advantageous Effects

The optical laminate according to the present disclosure and the image display device including the same have less occurrence of curls or cracks due to curing shrinkage, and have excellent adhesion, pen usability, curl characteristics, water contact angle, and scratch resistance, so that when applied to a flexible display, device reliability may be improved.

In addition, the optical laminate according to the present disclosure is formed by direct contact without including a separate substrate between glass and the hard coating layer, so that a process for bonding each substrate layer can be omitted, and thus the manufacturing process may be simplified compared to the conventional one.

### DESCRIPTION OF DRAWINGS

FIG. 1 illustrates a laminated structure of an optical laminate according to one embodiment of the present disclosure.

What each symbol represents is as follows:
100: Optical laminate
110: Glass
120a: First hard coating layer
120b: Second hard coating layer

### SPECIFIC DETAILS FOR CARRYING OUT THE INVENTION

The present disclosure relates to an optical laminate including: glass; a first hard coating layer formed on the glass; and a second hard coating layer formed on the first hard coating layer, wherein the first hard coating layer is formed of a first hard coating composition comprising an epoxy acrylic resin and an epoxy silane coupling agent, and the second hard coating layer is formed of a second hard coating composition comprising a light-transmitting resin, and an image display device including the same.

Hereinafter, preferred embodiments of the present disclosure will be described in detail. However, these embodiments are merely presented exemplarily to more specifically explain the present disclosure, and it will be obvious to those skilled in the art that the scope of the present disclosure is not limited by these embodiments.

The terms used in the present specification are for the purpose of describing embodiments and are not intended to limit the present disclosure. In the present specification, singular forms also include plural forms unless specifically stated otherwise in the phrases. For example, the “hard coating layer” used in the present specification may mean at least one hard coating layer out of the first hard coating layer and the second hard coating layer.

The terms “comprises” and/or “comprising” used in the present specification are used to mean that they do not exclude the presence or addition of one or more other components, steps, operations, and/or elements other than the mentioned components, steps, operations, and/or elements. The same reference numerals refer to the same components throughout the specification.

“Transparent” used in the present specification means that the visible light transmittance is 70% or more or 80% or more.

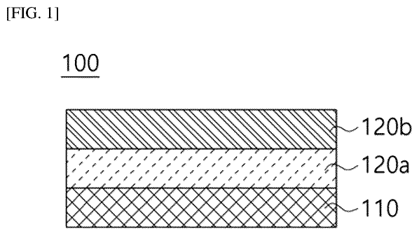

FIG. 1 illustrates a laminated structure of an optical laminate according to one embodiment of the present disclosure, and the optical laminate 100 of the present disclosure may be a structure including, as shown in FIG. 1, glass 110; a first hard coating layer 120a formed on the glass 110; and a second hard coating layer 120b formed on the first hard coating layer, i.e., on the outermost portion.

The optical laminate of the present disclosure may have both hardness and flexibility in order to be applied to a window for a flexible display.

### <Optical Laminate>

The optical laminate of the present disclosure includes glass and a hard coating layer, and may preferably include a first hard coating layer and a second hard coating layer. More specifically, the optical laminate of the present disclosure includes: glass; a first hard coating layer formed on the glass; and a second hard coating layer formed on the first hard coating layer, wherein the first hard coating layer may be formed of a first hard coating composition comprising an epoxy acrylic resin and an epoxy silane coupling agent, and the second hard coating layer may be formed of a second hard coating composition comprising a light-transmitting resin.

### Glass 110

Glass is intended to replace the existing glass substrate and support the hard coating layer 120 to be described later and other substrates or panels, and may be formed of either thin glass or curved glass for the display of an electronic device. Thin glass may include flat glass and flexible glass.

As glass 110 according to one embodiment of the present disclosure, any transparent glass may be used without limitation, and preferably silicate glass may be used. Silicate glass is glass mainly composed of anhydrous silica (silica) that exists naturally in the form of silica, and since the structure of silicate glass has a very high density and very strong bonds with oxygen and water, it exhibits low transmittance, making it preferable to be used as a display substrate.

In addition, glass used for the substrate is preferably thin glass (TG) having a thickness of 10 to 300 μm. Unlike existing glass, in order to have excellent bending resistance by which the glass does not break even when bent or folded for use in a flexible display substrate, it is more preferable to have a thickness of 100 μm or less, and glass with a thickness thinner than 10 μm has a problem that it is easy to break during the process.

The optical laminate according to the present disclosure may include an additional substrate layer such as a hard coating layer 120 to be described later in order to secure the durability of the glass 110. Generally, an adhesive layer or a pressure-sensitive adhesive layer is included to form or bond the substrate layer, but the optical laminate according to the present disclosure is characterized in that a hard coating layer is formed through direct contact without including a separate substrate layer for bonding the hard coating layer, so that the manufacturing process may be simplified compared to the existing laminate.

### Hard Coating Layer 120

The hard coating layer of the present disclosure may include a first hard coating layer 120a and a second hard coating layer 120b as shown in FIG. 1.

According to one embodiment of the present disclosure, the first hard coating layer 120a is characterized in that it is formed of a first hard coating composition comprising an epoxy acrylic resin and an epoxy silane coupling agent, and the epoxy acrylic resin and the epoxy silane coupling agent are included, and accordingly, adhesion to the glass 110 can be secured and low-curl and high-hardness characteristics can be secured. The second hard coating layer 120b is characterized in that it is formed of a second hard coating composition comprising a light-transmitting resin.

Referring to FIG. 1, the first hard coating layer 120a is formed on the glass 110, and the second hard coating layer 120b may be formed on the first hard coating layer 120a, i.e., on the outermost portion of the optical laminate. The first hard coating layer 120a secures adhesion between substrates even without a separate substrate layer such as a pressure-sensitive adhesive layer, and provides impact resistance.

In addition, the optical laminate according to the present disclosure and the image display device having the same applied thereto secure sufficient impact resistance even when a separate protective film is not applied, so that thin film glass is not damaged even when pressure is applied to the display surface with a pen, and thus the usability of the pen may be greatly improved.

In addition, the first hard coating composition and the second hard coating composition may each independently further include one or more selected from the group consisting of an additive, an initiator, and a solvent, and the additive may include one or more selected from the group consisting of a silicone-based leveling agent, an ultraviolet stabilizer, a heat stabilizer, and the like. For example, the first hard coating layer may be prepared from a hard coating composition comprising an epoxy acrylic resin, an epoxy silane coupling agent, a silicone-based leveling agent, an initiator, and a solvent, and the second hard coating layer may be prepared from a hard coating composition comprising a light-transmitting resin, a silicone-based leveling agent, an initiator, and a solvent.

### Epoxy Acrylic Resin

The epoxy acrylic resin has epoxy and acrylic groups as thermosetting and photocuring functional groups in the molecule, and includes partially esterified epoxy (meth)acrylate, etc. As commercially available products, the photocurable acrylic polymer type SMP-220AP-E5 of Kyoeisha Chemical Co., Ltd., which has acrylic and epoxy groups, the partially esterified epoxy bisphenol A type 3000A-E5, 3000AD-E5, and 3000AL-E5 of Kyoeisha, which have epoxy and acrylic groups, and the partially esterified epoxy bisphenol A type 3000M-E5, 3000MD-E5, 3000ML-E5, etc., which have epoxy and methacrylic groups, can be used.

It is preferable that the epoxy acrylic resin is included in an amount of 20 to 80 parts by weight with respect to 100 parts by weight of the total first hard coating composition. If it is less than 20 parts by weight, thick film coating is impossible, resulting in reduced hardness, and if it exceeds 80 parts by weight, the solubility of the composition is reduced, and the viscosity increases so that there is a problem in that it is difficult to secure application properties.

### Epoxy Silane Coupling Agent

The epoxy silane coupling agent refers to a compound having an epoxy group in the organic reactive group of the silane coupling agent. Specifically, it refers to a compound containing an epoxy group in R1 in the structure of R1ₓ-Si—(OR₂)₄₋ₓ (X is an integer of 1 to 3, and R₂ is an alkyl group such as methyl, ethyl, propyl, or the like). For example, the epoxy silane coupling agent may include one or more selected from 3-glycidoxypropyldimethoxysilane, 3-glycidoxypropyltrimethoxysilane, 8-glycidoxyoctyltrimethoxysilane, and 2-(3,4-epoxycyclohexyl)ethyltrimethoxysilane.

As commercially available products of the epoxy silane coupling agent, KBM-303, KBM-402, KBM-403, KBM-4803, KBE-402, KBE-403, X-12-981S, X-12-984S, KR-516, KR-517, etc. of Shin-Etsu Corporation may be used.

The epoxy silane coupling agent may be included preferably in an amount of 1 to 30 parts by weight, more preferably 3 to 20 parts by weight, based on 100 parts by weight of the total hard coating composition. The epoxy silane coupling agent is included within the above range so that the adhesion to glass may be improved and flexibility may be imparted to the hard coating layer. When it is included in an amount less than the above range, there is a problem in that the adhesion to glass is not sufficiently secured, and when it is included in an amount exceeding the above range, there is a concern that the optical characteristics may deteriorate due to scattering due to poor compatibility.

### Light-Transmitting Resin

The light-transmitting resin is a photocurable resin, and the photocurable resin may include a photocurable (meth)acrylate oligomer and a photopolymerizable monomer.

In the present disclosure, “(meth)acrylic-” refers to “methacrylic-”, “acrylic-”, or both.

Epoxy (meth)acrylate, urethane (meth)acrylate, etc. are typically used as the photocurable (meth)acrylate oligomer, and urethane (meth)acrylate is more preferred. Urethane (meth)acrylate can be produced in the presence of a catalyst using a polyfunctional (meth)acrylate having a hydroxyl group in the molecule and a compound having an isocyanate group. Specific examples of the (meth)acrylate having a hydroxy group in the molecule may include one or more selected from the group consisting of 2-hydroxyethyl (meth)acrylate, 2-hydroxyisopropyl (meth)acrylate, 4-hydroxybutyl (meth)acrylate, caprolactone ring-opening hydroxyacrylate, pentaerythritol tri/tetra (meth)acrylate, and dipentaerythritol penta/hexa (meth)acrylate. In addition, specific examples of the compound having an isocyanate group may include one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexenediisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenylisocyanate), 4,4′-oxybis(phenyl isocyanate), a trifunctional isocyanate derived from hexamethylene diisocyanate, and a trimethanepropanol adduct toluene diisocyanate.

The photopolymerizable monomer is a commonly used photocurable functional group, and for example, a monomer used in the relevant technical field having an unsaturated group such as a (meth)acryloyl group, a vinyl group, a styryl group, an allyl group, or the like in the molecule can be used without limitation, but a (meth)acryloyl group among them is more preferable. More specifically, examples thereof may include monofunctional and/or polyfunctional (meth)acrylates. These may be used alone or in combination of two or more.

Specific examples of the monomer having the (meth)acryloyl group may include one or more selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra (meth)acrylate, pentaglycerol tri(meth)acrylate, pentaerythritol tetra(meth)acrylate, pentaerythritol tri(meth)acrylate, dipentaerythritol tri(meth)acrylate. dipentaerythritol penta(meth)acrylate, dipentaerythritol tetra(meth)acrylate, dipentaerythritol hexa(meth)acrylate, tripentaerythritol tri(meth)acrylate, tripentaerythritol hexatri(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, and isobornyl (meth)acrylate.

The light-transmitting resin is not particularly limited, but is preferably included in an amount of 1 to 80 parts by weight based on 100 parts by weight of the total hard coating composition. When it is included in an amount of less than 1 parts by weight, it is difficult to sufficiently improve hardness, and when it is included in an amount exceeding 80 parts by weight, there is a problem in that curling becomes severe.

### Additives

In addition, the hard coating composition used for the formation of the hard coating layer according to the present disclosure may further include additives such as a leveling agent, an ultraviolet stabilizer, and/or a heat stabilizer.

The leveling agent is a component that provides smoothness and coating properties to the coating film.

A leveling agent commonly used in the art can be applied as the leveling agent, and for example, the leveling agent may include silicone-based leveling agents, fluorine-based leveling agents, acrylic polymer-based leveling agents, etc. These may be used alone or in combination of two or more, but are not necessarily limited to these.

Commercially available products of the leveling agent may include: BYK-323, BYK-331, BYK-333, BYK-337, BYK-373, BYK-375, BYK-377, BYK-378, BYK-3530, BYK-3560, BYK-358N, and BYK-361N from BYK Chemie; TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, and TEGO Rad 2500 from Degussa; and FC-4430, FC-4432, etc. from 3M, but are not limited thereto, and leveling agents commonly used in the art can be applied.

The leveling agent may be included in an amount of 0.1 to 1 part by weight based on 100 parts by weight of the hard coating composition, but is not limited thereto. However, when the leveling agent is included in an amount within the above range with respect to the hard coating composition, there is an advantage in that the excellent hardness and flexibility can be maintained while maximizing the smoothness and coating properties of the coating film.

The ultraviolet stabilizer is a component that blocks or absorbs ultraviolet rays, thereby preventing decomposition, discoloration, and crumbling of the cured hard coating layer due to exposure to ultraviolet rays.

The ultraviolet stabilizer may include: absorbers, quenchers, and hindered amine light stabilizers (HALS), which are classified according to their mechanism of action; phenyl salicylates (absorbers), benzophenone (absorbers), benzotriazole (absorbers), nickel derivatives (quenchers), and radical scavengers, which are classified according to their chemical structure; etc. These can be used alone or in combination of two or more, and there are no particular limitations on the type of the ultraviolet stabilizer as long as it does not significantly change the initial color of the hard coating layer.

As the heat stabilizer, e.g., commercially applicable products, polyphenol-based heat stabilizers that are primary heat stabilizers, and phosphate-based heat stabilizers and lactone-based heat stabilizers that are secondary heat stabilizers can be used alone or in combination. These can be used alone or in combination of two or more. The ultraviolet stabilizer and heat stabilizer can be used by adjusting the content appropriately at a level that does not affect the ultraviolet curability, and specifically, it is preferable that they are included in an amount of 0.1 to 3 parts by weight with respect to the total 100 parts by weight of the hard coating composition of the present disclosure.

The additives can be added by adjusting the content appropriately within a range that does not hinder the effect of the present disclosure.

### Initiator

The initiator can be used without limitation as long as it is used in the relevant technical field. For example, one or more selected from the group consisting of hydroxyketones, aminoketones, hydrogen abstraction-type photoinitiators, and combinations thereof may be used.

Specifically, the photoinitiator may include one or more selected from the group consisting of 2-methyl-1-[4-(methylthio)phenyl]2-morpholinopropanone-1, diphenyl ketone, benzyl dimethyl ketal, 2-hydroxy-2-methyl-1-phenyl-1-one, 4-hydroxycyclophenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl (2,4,6-trimethylbenzoyl) phosphine oxide, and combinations thereof.

Such a photoinitiator is used in a range of 0.1 to 10 parts by weight, preferably 1 to 5 parts by weight, based on 100 parts by weight of the total hard coating composition. If the content is less than the above range, the curing speed of the composition is slow and under-curing occurs, resulting in lowered mechanical properties, and on the contrary, if the content exceeds the above range, cracks may occur in the coating film due to over-curing.

### Solvent

The solvent, as one that can dissolve or disperse the above-mentioned composition, can be used without limitation as long as it is known as a solvent for a composition for the formation of a coating layer in the technical field of the present disclosure.

Available solvents may preferably include alcohol-based solvents (methanol, ethanol, isopropanol, butanol, methyl cellosolve, ethyl cellosolve, and the like), ketone-based solvents (methyl ethyl ketone, methyl butyl ketone, methyl isobutyl ketone, diethyl ketone, dipropyl ketone, cyclohexanone, and the like), acetate-based solvents (ethyl acetate, propyl acetate, normal butyl acetate, tert-butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, and the like), hexane-based solvents (hexane, heptane, octane, and the like), benzene-based solvents (benzene, toluene, xylene, and the like), ether-based solvents (diethylene glycol dimethyl ether, diethylene glycol diethyl ether, diethylene glycol dipropyl ether, diethylene glycol dibutyl ether, propylene glycol monomethyl ether, and the like), etc. The solvents exemplified above can be used alone or in combination of two or more.

Such a solvent is used in an amount of 50 to 98 parts by weight based on 100 parts by weight of the total hard coating composition. If the content of the solvent is less than the content, the viscosity is high, which not only reduces workability, but also makes it impossible to reduce the thickness of the hard coating layer, which may result in reduced flexibility. On the other hand, if the content of the solvent exceeds the range, there are problems in that the desired film thickness cannot be formed, and the coating liquid may flow down during the drying process, contaminating the opposite surface of glass or film, and causing stains. Therefore, it is necessary to appropriately adjust the content of the solvent within the range.

The hard coating layer may be manufactured by a method known in the art. The thickness of the first hard coating layer and the second hard coating layer is not particularly limited, but the thickness of the first hard coating layer may be preferably 5 to 100 μm, and more preferably 10 to 30 μm. The thickness of the second hard coating layer may be preferably 3 to 20 μm, and more preferably 5 to 15 μm. When the thickness is within the above range, more excellent hardness and flexibility may be exhibited. When the thicknesses of the first hard coating layer and the second hard coating layer are outside the above range, there is a problem in that sufficient hardness and curl characteristics are not secured.

In the optical laminate according to an embodiment of the present disclosure, a first hard coating layer 120a may be formed by coating a first hard coating composition on the glass 110 and performing drying and UV curing steps. Thereafter, a second hard coating layer 120b may be formed by coating a second hard coating composition on the first hard coating layer 120a and then performing drying and UV curing steps in the same manner as the first hard coating layer.

The step of drying the optical laminate may be performed by a heating means such as a hot plate, a hot air circulation furnace, an infrared furnace, or the like, and may be performed at a temperature of 50 to 150° C. or 50 to 100° C.

The step of curing the optical laminate is irradiating an active ray such as UV light or the like of 50 to 1000 mJ/cm², preferably 200 to 800 mJ/cm². In particular, the step of forming the first hard coating layer 120a may be performed by performing primary curing weakly at a level of 50 to 600 mJ/cm², and the step of forming the second hard coating layer 120b may be performed by irradiating UV with a strong light amount of 300 to 800 mJ/cm², thereby further strengthening the adhesion between the second hard coating layer and the first hard coating layer. As a light source used for irradiation, a low-pressure mercury lamp, a high-pressure mercury lamp, an ultra-high pressure mercury lamp, a metal halide lamp, an argon gas laser, etc. may be used, and in some cases, X-rays, electron beams, etc. may also be used.

### <Image Display Device>

Embodiments of the present disclosure provide an image display device including the optical laminate described above.

For example, the optical laminate described above may be inserted into the interior of an image display device so that it may be included together with a polarizing layer or a touch sensor layer.

The image display device may include various image display devices such as a liquid crystal display device, an electroluminescent display device, a plasma display device, a field emission display device, etc., and may be a flexible display device having flexibility and bending characteristics.

In this case, the optical laminate according to the embodiments of the present disclosure may be more effectively applied as a window or window laminate of a flexible display device. Through the interaction of glass and the hard coating layer included in the optical laminate according to the embodiments of the present disclosure, the flexibility and durability of the window are improved together, and antistatic performance may be implemented together. Accordingly, for example, the impact resistance and wear resistance of the flexible display device are improved, and at the same time, damage such as cracks and peeling may be prevented even when flexing or bending.

Hereinafter, embodiments of the present disclosure will be specifically described. However, the present disclosure is not limited to the embodiments disclosed below, but may be implemented in various different forms, and these embodiments are provided only to make the disclosure of the present disclosure complete and to completely inform those skilled in the art to which the present disclosure pertains of the scope of the invention, and the present disclosure is defined only by the scope of the claims. “%” and “part” are mass % and mass part, respectively, unless specifically stated.

### PREPARATION EXAMPLE: PREPARATION OF HARD COATING COMPOSITION

### Preparation Example 1

40 part by weight of epoxy acrylate (Kyoeisha, SMP-220AP-E5), 5 part by weight of an epoxy silane coupling agent (Shin-Etsu, KBM-403), 50 part by weight of propylene glycol monomethyl ether, 2.25 part by weight of a photoacid generator (Irgacure 250), 2.25 part by weight of a photoradical initiator (1-hydroxycyclohexyl phenyl ketone), and 0.5 part by weight of a silicone-based leveling agent (BYK, BYK-UV3530) were mixed using a stirrer and filtered using a filter made of polypropylene (PP) to prepare a first hard coating composition.

### Preparation Example 2

5 part by weight of dendrimer acrylate (Miwon Specialty Chemical Co., Ltd., SP1106), 40 part by weight of dipentaerythritol hexaacrylate (Miwon Specialty Chemical Co., Ltd., Miramer M600), 50 part by weight of methyl ethyl ketone, 3 part by weight of 1-hydroxycyclohexyl phenyl ketone, 3 part by weight of a fluorine-based leveling agent (DAC-HP, Daikin), and 2 part by weight of an antistatic agent ATO dispersion (methyl ethyl ketone dispersion) were mixed using a stirrer and filtered using a filter made of polypropylene (PP) to prepare a second hard coating composition.

### Preparation Example 3

45 parts by weight of epoxy acrylate (Kyoeisha, SMP-220AP-E5), 50 parts by weight of propylene glycol monomethyl ether, 2.25 parts by weight of a photoacid generator (Irgacure 250), 2.25 parts by weight of a photoradical initiator (1-hydroxycyclohexyl phenyl ketone), and 0.5 parts by weight of a silicone-based leveling agent (BYK, BYK-UV3530) were mixed using a stirrer and filtered using a filter made of polypropylene (PP) to prepare a first hard coating composition.

### Preparation Example 4

40 parts by weight of epoxy acrylate (Kyoeisha, SMP-220AP-E5), 5 parts by weight of an epoxy silane coupling agent (Shin-Etsu, KBM-4803), 50 parts by weight of propylene glycol monomethyl ether, 2.25 parts by weight of a photoacid generator (Irgacure 250), 2.25 parts by weight of a photoradical initiator (1-hydroxycyclohexyl phenyl ketone), and 0.5 parts by weight of a silicone-based leveling agent (BYK, BYK-UV3530) were mixed using a stirrer and filtered using a filter made of polypropylene (PP) to prepare a first hard coating composition.

### Examples and Comparative Examples: Manufacturing of Optical Laminates

The hard coating compositions of Preparation Examples 1 to 4 were laminated in the order and thicknesses described in Table 1 below to manufacture optical laminates of Examples and Comparative Examples.

Specifically, in the case of Examples 1 to 4, the hard coating composition of Preparation Example 1 was coated on thin glass, and then the solvent was dried at 90° C. for 2 minutes. The dried coating film was purged with nitrogen, and UV was irradiated at a light dose of 500 mJ/cm² under nitrogen conditions to form a first hard coating layer (HC1). The hard coating composition of Preparation Example 2 was coated on the formed first hard coating layer, and then the solvent was dried at 90° C. for 2 minutes. The dried coating film was purged with nitrogen, and UV was irradiated at a light dose of 500 mJ/cm² under nitrogen conditions to form a second hard coating layer (HC2), thereby manufacturing a final optical laminate.

In the case of Example 5, the hard coating composition of Preparation Example 4 was coated on thin glass, and then the solvent was dried at 90° C. for 2 minutes. The dried coating film was purged with nitrogen, and UV was irradiated at a light dose of 500 mJ/cm² under nitrogen conditions to form a first hard coating layer (HC1). The hard coating composition of Preparation Example 2 was coated on the formed first hard coating layer, and then the solvent was dried at 90° C. for 2 minutes. The dried coating film was purged with nitrogen, and UV was irradiated at a light dose of 500 mJ/cm² under nitrogen conditions to form a second hard coating layer (HC2), thereby manufacturing a final optical laminate.

In the case of Comparative Example 1, the hard coating composition of Preparation Example 2 was coated on thin glass, and then the solvent was dried at 90° C. for 2 minutes. The dried coating film was purged with nitrogen, and UV was irradiated with a light dose of 500 mJ/cm² under nitrogen conditions to form a hard coating layer, thereby manufacturing a final optical laminate.

In the case of Comparative Example 2, the hard coating composition of Preparation Example 1 was coated on thin glass, and then the solvent was dried at 90° C. for 2 minutes. The dried coating film was purged with nitrogen, and UV was irradiated with a light dose of 500 mJ/cm² under nitrogen conditions to form a hard coating layer, thereby manufacturing a final optical laminate.

In the case of Comparative Example 3, the hard coating composition of Preparation Example 2 was coated on thin glass, and then the solvent was dried at 90° C. for 2 minutes. The dried coating film was purged with nitrogen, and UV was irradiated with a light dose of 500 mJ/cm² under nitrogen conditions to form a hard coating layer, thereby manufacturing a final optical laminate.

In the case of Comparative Example 4, the hard coating composition of Preparation Example 3 was coated on thin glass, and then the solvent was dried at 90° C. for 2 minutes. The dried coating film was purged with nitrogen, and UV was irradiated with a light dose of 500 mJ/cm² under nitrogen conditions to form a first hard coating layer (HC1). The hard coating composition of Preparation Example 2 was coated on the formed first hard coating layer, and then the solvent was dried at 90° C. for 2 minutes. The dried coating film was purged with nitrogen, and UV was irradiated with a light dose of 500 mJ/cm² under nitrogen conditions to form a second hard coating layer (HC2), thereby manufacturing a final optical laminate.

TABLE 1
(Unit: μm)

| | Thickness | Thickness of | Thickness of |
|---|---|---|---|
| | of thin | the first hard | the second hard |
| Classification | glass | coating layer | coating layer |
| Example 1 | 30 | 15 | 5 |
| Example 2 | 30 | 20 | 5 |
| Example 3 | 30 | 15 | 15 |
| Example 4 | 50 | 15 | 5 |
| Example 5 | 30 | 15 | 15 |
| Comparative | 30 | — | 5 |
| Example 1 | | | |
| Comparative | 30 | 15 | — |
| Example 2 | | | |
| Comparative | 30 | — | 20 |
| Example 3 | | | |
| Comparative | 30 | 15 | 15 |
| Example 4 | | | |

### Experimental Example

The physical properties of the optical laminates manufactured in Examples 1 to 5 and Comparative Examples 1 to 4 were measured by the following methods, and the results are shown in Table 2.

### (1) Transmittance Evaluation

The optical laminates of the Examples and Comparative Examples were measured for transmittance using Murakami Corporation's Haze Meter HM-150N.

### (2) Haze Evaluation

The optical laminates of the Examples and Comparative Examples were measured for haze using Murakami Corporation's Haze Meter HM-150N.

### (3) Adhesion Evaluation

The optical laminates of the Examples and Comparative Examples were bonded to glass using a transparent pressure-sensitive adhesive so that the hard coating surface was facing upward, and then the hard coating surface was scratched with a cutter knife in the shape of 100 squares in width and length at 1 mm intervals, and then an adhesion test was performed three times using Nichiban tape.

### Evaluation Criteria

5B: Unpeeled
4B: Less than 5% peeled
3B: 5% or more to less than 15% peeled
2B: 15% or more to less than 35% peeled
1B: 35% or more to less than 65% peeled
0B: 65% or more peeled

### (4) Pen Usability Evaluation

A polymer film assembly manufactured to be similar to the display panel structure was bonded to lower parts of the optical laminates of the Examples and Comparative Examples, and the hard coating layer was fixed so that it was on the top, and then the impact resistance was evaluated by performing the test 5 times with a 3H hardness pencil at a length of 1 cm under a load of 1 kg.

A polymer film assembly similar to the display panel structure was manufactured by bonding 25 μm transparent pressure-sensitive adhesive/75 μm polarizing film/35 μm PI film/25 μm transparent pressure-sensitive adhesive/35 μm PI film to have a total thickness of 195 μm, and the polarizing film-side pressure-sensitive adhesive layer and the opposite surfaces of the hard coating layers of the optical laminates were bonded to manufacture evaluation samples.

### Evaluation Criteria

⊚: Glass is not broken
◯: Hard coating layer is pressed (it is restored to unpressed state after 24 hours)
Δ: Hard coating layer is pressed (it is not restored to unpressed state after 24 hours)
X: Glass is broken

### (5) Curl Characteristic Evaluation

After the optical laminates of the Examples and Comparative Examples were left for 24 hours under conditions of 25° C. and 50% relative humidity so that the hard coating layer surface was facing upward, distances between the bottom and four apexes were measured and the average value was recorded. In the case of reverse curl, where curl occurs in the opposite direction of the second hard coating layer surface, the distances between the bottom and the apexes were measured and calculated after flipping thin glass over.

### Evaluation Criteria

⊚: 5 mm or less)
◯: more than 5 to less than 10 mm
Δ: 10 mm or more to less than 20 mm
X: 20 mm or more

### (6) Initial Water Contact Angle Evaluation

The water contact angles of the coating surfaces of the optical laminates manufactured in the Examples and Comparative Examples were measured. (Using KRUSS contact angle meter DSA100)

### (7) Scratch Resistance Evaluation

After fixing the coating surfaces of the optical laminates manufactured in the Examples and Comparative Examples so that they faced upward, whether scratches occurred on the surfaces of the optical laminates or not was visually checked after performing 10 times of reciprocating friction with a load of 250 g/cm² using steel wool (#0000).

### Evaluation Criteria

◯: When the measuring section is observed by transmitting and reflecting with a three-wavelength lamp, no scratches are visible or 10 or fewer scratches are visible.
X: When the measuring section is observed by transmitting and reflecting with a three-wavelength lamp, more than 10 scratches are visible.

TABLE 2

| | | | | | | Water | |
|---|---|---|---|---|---|---|---|
| | Transmittance | Haze | | Pen | | contact | Scratch |
| Classification | [%] | [%] | Adhesion | usability | Curl | angle [°] | resistance |
| Example 1 | 91.4 | 0.1 | 5B | ◯ | ⊚ | 112 | ◯ |
| Example 2 | 91.1 | 0.2 | 5B | ◯ | ⊚ | 111 | ◯ |
| Example 3 | 91.3 | 0.3 | 5B | ⊚ | ◯ | 110 | ◯ |
| Example 4 | 91.5 | 0.2 | 5B | ⊚ | ⊚ | 111 | ◯ |
| Example 5 | 91.2 | 0.3 | 5B | ⊚ | ◯ | 110 | ◯ |
| Comparative | 91.8 | 0.1 | 0B | X | ⊚ | 111 | ◯ |
| Example 1 | | | | | | | |
| Comparative | 91.5 | 0.3 | 5B | Δ | ⊚ | 89 | X |
| Example 2 | | | | | | | |
| Comparative | 91.4 | 0.2 | 0B | ⊚ | X | 110 | ◯ |
| Example 3 | | | | | | | |
| Comparative | 91.3 | 0.2 | 0B | ⊚ | ◯ | 111 | ◯ |
| Example 4 | | | | | | | |

Referring to the experimental data in Table 2 above, in the case of Examples 1 to 5 in which optical laminates including a two-layer hard coating layer according to the present disclosure were applied, excellent results were all shown in the evaluations of adhesion, pen usability, curl characteristics, water contact angle, and scratch resistance, whereas in the case of the optical laminates of Comparative Examples 1 to 3 including only a one-layer hard coating layer, as one or more evaluation criteria among the evaluations of adhesion, pen usability, curl characteristics, water contact angle, and scratch resistance did not reach the present disclosure, physical properties suitable for an optical laminate for a flexible display were not exhibited.

In particular, in the case of Comparative Examples 1 and 3 that do not include the first hard coating layer according to the present disclosure, peeling occurred by 65% or more in the adhesion evaluation so that sufficient adhesion with glass was not secured, and in the case of Comparative Example 2 that does not include the second hard coating layer according to the present disclosure, scratches were confirmed in the scratch resistance evaluation. In addition, in the case of Comparative Example 1 that does not include the first hard coating layer according to the present disclosure and has a thickness of the second hard coating layer of 5 μm, glass was broken in the pen usability evaluation, so it could be confirmed that it is not suitable as a use for protecting glass. In addition, in the case of Comparative Example 2 that does not include the second hard coating layer according to the present disclosure, the hard coating layer was pressed in the pen usability evaluation, so it is not suitable as a use for protecting glass, and the water contact angle was measured to be less than 95°, and in the case of Comparative Example 3 that does not include the first hard coating layer according to the present disclosure and has a thickness of the second hard coating layer of more than 15 μm, severe curling occurred due to curing shrinkage in the curl characteristic evaluation. In the case of Comparative Example 4 that does not include the epoxy silane coupling agent according to the present disclosure, since peeling occurred by 65% or more in the adhesion evaluation the adhesion to glass was not sufficiently secured, and physical properties suitable for an optical laminate for a flexible display could not be exhibited.

Accordingly, it can be confirmed that the optical laminate according to the present disclosure and the image display device applying the same have excellent adhesion, pen usability, water contact angle, and scratch resistance, with little occurrence of curling due to curing shrinkage even at a thickness of 15 μm or more, and thus have the effect of improving device reliability when applied to a flexible display.

1. An optical laminate comprising:
glass;
a first hard coating layer formed on the glass; and
a second hard coating layer formed on the first hard coating layer,
wherein the first hard coating layer is formed of a first hard coating composition comprising an epoxy acrylic resin and an epoxy silane coupling agent, and
the second hard coating layer is formed of a second hard coating composition comprising a light-transmitting resin.

2. The optical laminate of claim 1, wherein glass has a thickness of 10 to 100 μm.

3. The optical laminate of claim 1, wherein the first hard coating layer has a thickness of 10 to 30 μm.

4. The optical laminate of claim 1, wherein the second hard coating layer has a thickness of 3 to 20 μm.

5. The optical laminate of claim 1, wherein one or more of the first hard coating composition and the second hard coating composition further comprise an additive.

6. The optical laminate of claim 5, wherein the additive includes one or more selected from the group consisting of a silicone-based leveling agent, an ultraviolet stabilizer, and a heat stabilizer.

7. The optical laminate of claim 1, wherein one or more hard coating compositions of the first hard coating composition and the second hard coating composition further comprise an initiator and a solvent.

8. The optical laminate of claim 7, wherein the first hard coating composition comprises, based on the total weight of the composition, 20 to 80 parts by weight of an epoxy acrylic resin; 1 to 30 parts by weight of an epoxy silane coupling agent; 0.1 to 10 parts by weight of an initiator; and 50 to 98 parts by weight of a solvent.

9. The optical laminate of claim 7, wherein the second hard coating composition comprises, based on the total weight of the composition, 1 to 80 parts by weight of a light-transmitting resin; 0.1 to 10 parts by weight of an initiator; and 50 to 98 parts by weight of a solvent.

10. The optical laminate of claim 1, wherein the epoxy silane coupling agent includes one or more selected from 3-glycidoxypropyldimethoxysilane, 3-glycidoxypropyltrimethoxysilane, 8-glycidoxyoctyltrimethoxysilane, and 2-(3,4-epoxycyclohexyl)ethyltrimethoxysilane.

11. The optical laminate of claim 1, wherein the light-transmitting resin includes one or more selected from 2-hydroxyethyl (meth)acrylate, 2-hydroxyisopropyl (meth)acrylate, 4-hydroxybutyl (meth)acrylate, caprolactone ring-opening hydroxyacrylate, pentaerythritol tri/tetra (meth)acrylate, and dipentaerythritol penta/hexa (meth)acrylate.

12. The optical laminate of claim 1, wherein glass, the first hard coating layer, and the second hard coating layer are characterized in that they are formed by directly contacting each other without including a separate layer.

13. The optical laminate of claim 1, wherein the optical laminate is for being applied to a flexible display.

14. An image display device comprising the optical laminate according claim 1.
